(19) United States
(12) Patent Application Publication
(10) Pub. No.: US 2012/0280926 A1
(43) Pub. Date: Nov. 8, 2012

(54) CLIP-ON TOUCH-SENSITIVE DEVICE FOR DISPLAY DEVICE

(76) Inventors: Jean-Marie GOY, Gradignan (FR); Daniel Laret, St Medard En Jalles (FR)

(21) Appl. No.: 13/463,760

(22) Filed: May 3, 2012

(30) Foreign Application Priority Data
May 5, 2011 (FR) 11 01387

(51) Int. Cl. G06F 3/041

(52) U.S. Cl. 345/173

(57) ABSTRACT

The general field of the invention is that of touch-sensitive devices comprising a touch-sensitive screen connectable to a display device of the aeronautical type including at least a front face, a rear face and a locking handle situated on the front face. The touch-sensitive screen according to the invention comprises at least, fixed onto its members, two fastening clips and two retaining clips, all four clips ensuring the fastening of the touch-sensitive screen on the front face of the display device when the locking handle is in the locked position, the retaining clips being locked by the lateral arms of said locking handle.

The field of the invention is that of touch-sensitive screen devices fitted onto display devices. The main application relates to the display screens of aircraft instrument panels.

There are different man-machine interfaces for monitoring, modifying or controlling the display of display devices. For several years and particularly in the general public area of IT or telephony, touch-sensitive screens have been used to achieve these interfaces, the user modifying the data of a display system either directly with his hand, or by means of a stylus.

Different technical principles are used to produce touch-sensitive screens. Electronic principles can be used where the approach to an object on the screen locally modifies an electrical parameter such as a resistor or a capacitor. Optical devices can also be used based on the use of light sources and micro-cameras that capture images of objects in the vicinity of the screen and determine the location of objects by triangulation.

For reasons of cost, size and reliability, the touch-sensitive surfaces used in the general public area or in other areas are not removable and form an integral part of the display device.

In the aeronautics field, some aircraft manufacturers wish to adapt the display systems of their instrument panels so that they include touch-sensitive control screens. A first solution consists in replacing the current display systems without touch-sensitive screens with systems with an integrated touch-sensitive screen. This solution is extremely expensive since it requires the complete retrofit of the instrument panel with the problems of certification and shutdown that this entails.

The touch-sensitive device according to the invention does not have its drawbacks. It has a touch-sensitive screen comprising attachment means and a connector adapted to be fixed simply on a large number of display devices without having to modify or dismantle them.

More precisely, the invention relates to a touch-sensitive device comprising at least a substantially rectangular touch-sensitive screen including two lateral members and two transverse members, said touch-sensitive device being connectable to a display device including at least a front face, a rear face and a locking handle situated on the front face and comprising two lateral arms, characterized in that the touch-sensitive screen comprises at least, fixed onto the members, two fastening clips and two retaining clips, all four clips ensuring the fastening of said detection frame on the front face of the display device when the locking handle is in the locked position, the retaining clips being locked by the lateral arms of said locking handle.

Advantageously, the touch-sensitive device comprises control and processing electronics connected to the detection frame via an electronic connection, said electronics being connectable to the rear face of the display device by means of an electrical connector.

Advantageously, the touch-sensitive screen comprises optical means for detecting the position of an object located inside the frame. These detection means are micro-cameras arranged along the members of the detection frame and retro-reflective strips arranged on the inner periphery of the detection frame.

Advantageously, the fastening clips are fixed onto the lateral members of the touch-sensitive screen and are U-shaped and the retaining clips are fixed onto the side members of the touch-sensitive screen and are L-shaped.

Advantageously, the front face of the display device comprises recesses adapted to the two fastening clips and the two retaining clips of the touch-sensitive screen.

Advantageously, the display device is an aeronautical display device intended to be integrated into an aircraft instrument panel.

The invention will be better understood and further advantages will become apparent upon reading the following description given by way of a non-restrictive example and thanks to the attached figures in which:

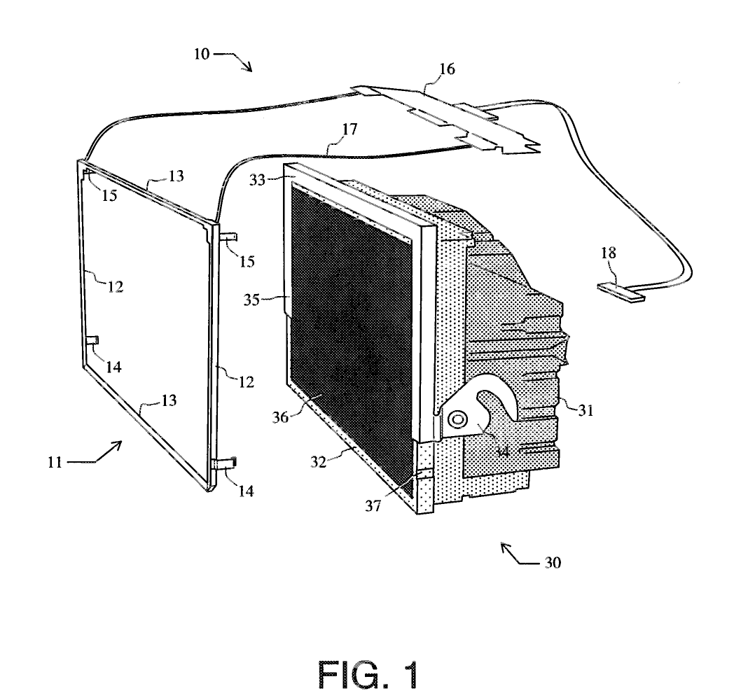

FIG. 1 shows a touch-sensitive screen according to the invention and the associated display device before fastening;

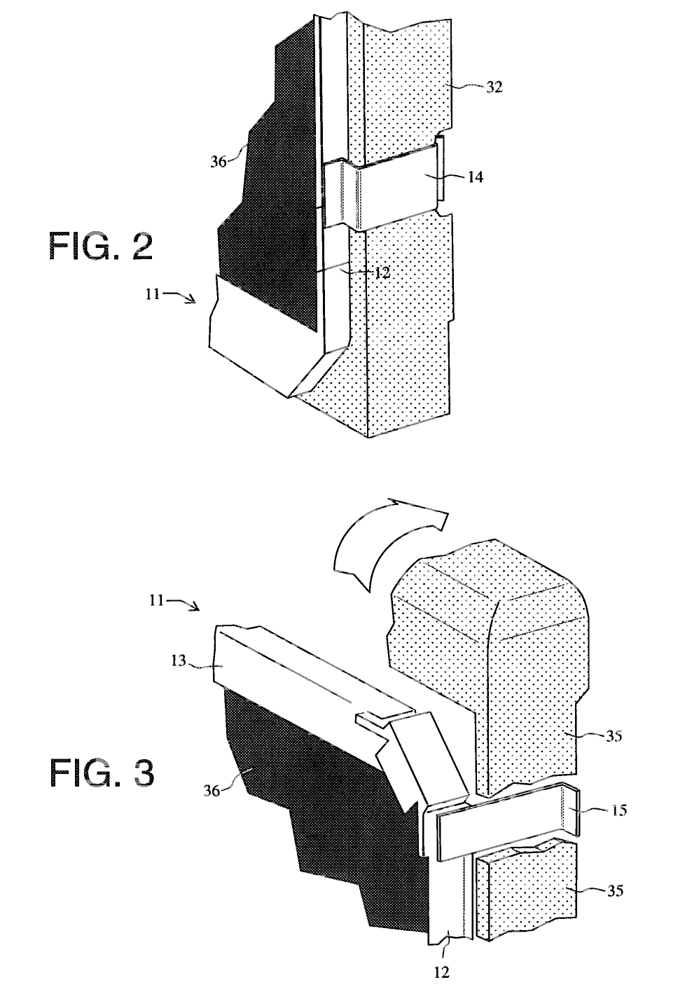

FIG. 2 shows a partial view of a fastening clip when the touch-sensitive screen is fitted onto the display device;

FIG. 3 shows a partial view of a retaining clip when the touch-sensitive screen is fitted onto the display device.

By way of a non-restrictive example, FIG. 1 shows a perspective view of a touch-sensitive device 10 according to the invention and the associated display device 30 before the detection frame is fastened.

The touch-sensitive device 10 operates, in the present case, by optical detection. Other detection techniques such as electronic detection are compatible with the invention.

The touch-sensitive device comprises:
a touch-sensitive screen 11 in the form of a substantially rectangular frame and including:
   two lateral members 12 and two transverse members 13;
   two fastening clips 14 and two retaining clips 15 fixed to the lateral members 12. In the case of FIG. 1, the fastening clips are situated at the bottom of the lateral members and the retaining clips at the top of the lateral arms. This arrangement can be modified to fit other types of display;
   illuminators and two micro-cameras housed in the transverse members 13 and not shown in FIG. 1;
   retro-reflective strips arranged on the inner periphery of the lateral and transverse members of the touch-sensitive screen 11, also not shown in FIG. 1;
control and processing electronics 16 connected to the touch-sensitive screen 11 via electronic connections 17 and including an electrical connector 18.

The operating principle of the touch-sensitive screen is as follows. The illuminators light up the retro-reflective strips 17. In the absence of any object inside the touch-sensitive frame, the micro-cameras capture a constant light signal. In the presence of an object inside the frame, it creates shadows on the images provided by the micro-cameras. The position of these shadows in the images is representative of the position of the object inside the frame. The images are processed by the control and processing electronics 16.

The display device 30 comprises mainly a housing 31 containing the control- and displayed image-generating electronics, a front face 32 including a display screen 36, generally a liquid crystal display. This device is known under the term “LCD” meaning “Liquid Crystal Display”. The display device comprises a locking handle 33 located on the front face, enabling the display device to be locked in an instrument panel by means of locking cams 34. This handle 33 comprises two lateral arms 35 for actuating the locking cams 34. In the locked position, the lateral arms 35 of the handle 33 rest on the front face 32.

The mechanical fastening of the touch-sensitive screen 11 onto the display device 30 is ensured by the four fastening and retaining clips. This is done in the following way:

The handle 33 being unlocked, the two fastening clips 14 of the touch-sensitive screen 11 are inserted on the sides of the front face 32 by acting on the elasticity of the clips 14 as seen in FIG. 2. The front face comprises recesses 37 reserved for these clips. In many applications, these recesses already exist and are used for fitting a protective shield for the front face, useful during the LCD production and assembly phases. The white arrow in FIG. 2 indicates the direction of movement of the detection frame when fitting the fastening clips. The shape of the clips 14 is adapted to the shape of the recesses 37 of the front face so that the residual clearance of the clips in their recesses is nearly zero. Thus, the horizontal and vertical positioning of the touch-sensitive screen 11 is perfectly determined. The accuracy of this positioning determines the accuracy of touch-sensitive designation in operational use.

Generally, the fastening clips 14 are U-shaped. They can be made of spring steel blades. After this operation, the detection frame of the touch-sensitive screen is then in place on the front face.

Then the locking handle 33 is placed in the locked position. The white arrow in FIG. 3 indicates the rotational movement of the handle. The lateral arms 35 then lock the two retaining clips 15. Generally, the retaining clips are L-shaped. They can also be made of spring steel blades. The length of these clips 15 is slightly shorter than the thickness of the handle at this point so as to assure a tight fit for the retaining clips 15 and perfect immobilization of the touch-sensitive screen. The detection frame of the touch-sensitive screen 11 is then locked against the front face 32.

Finally, the electronic control and processing electronics is connected to the rear of the display device by means of its electrical connector 18. The touch-sensitive device is then operational.

The main advantages of the touch-sensitive device according to the invention are:
the simplicity of the mechanical arrangements of the detection frame of the touch-sensitive device for being fitted to a display device;
in most applications, the total absence of adjustments of the display device comprising the touch-sensitive device;
the ease and speed of fitting the touch-sensitive device onto the display device which is done without tools;
the accuracy of fitting and perfect immobilization of the touch-sensitive screen;
the total invisibility of the assembly, once the touch-sensitive device is installed on its display device.

1. Touch-sensitive device comprising at least a substantially rectangular touch-sensitive screen including two lateral members and two transverse members, said touch-sensitive device being connectable to a display device including at least a front face, a rear face and a locking handle situated on the front face and comprising two lateral arms, wherein the touch-sensitive screen comprises at least, fixed onto the members, two fastening clips and two retaining clips, all four clips ensuring the positioning and fastening of the touch-sensitive screen on the front face of the display device when the locking handle is in the locked position, the retaining clips being locked by the lateral arms of said handle.

2. Touch-sensitive device according to claim 1, wherein said touch-sensitive device comprises control and processing electronics connected to the touch-sensitive screen via an electronic connection, said electronics being connectable to the rear face of the display device by means of an electrical connector.

3. Touch-sensitive device according to claim 1, wherein the touch-sensitive screen comprises optical means for detecting the position of an object located inside the frame of the touch-sensitive screen.

4. Touch-sensitive device according to claim 3, wherein the detection means are micro-cameras arranged along the members of the touch-sensitive screen and retro-reflective strips arranged on the inner periphery of the detection frame.

5. Touch-sensitive device according to claim 1, wherein the fastening clips are fixed onto the lateral members of the touch-sensitive screen and are U-shaped.

6. Touch-sensitive device according to claim 1, wherein the retaining clips are fixed onto the lateral members of the touch-sensitive screen and are L-shaped.

7. Display device including at least a front face, a rear face and a locking handle situated on the front face and comprising two lateral arms, said display device being connectable to a touch-sensitive screen claim 1, wherein the front face of said display device comprises recesses adapted to the two fastening clips and the two retaining clips of the touch-sensitive screen.

8. Display device according to claim 7, wherein said display device is an aeronautical display device intended to be integrated into an instrument panel.
